(19) United States
(12) Patent Application Publication
(10) Pub. No.: US 2026/0326672 A1
(43) Pub. Date: Oct. 22, 2026

(54) Multi-Funcation Car Seat Gap Filler

(71) Applicant: Siqing Xu, Shenzhen (CN)

(72) Inventor: Siqing Xu, Shenzhen (CN)

(21) Appl. No.: 19/185,272

(22) Filed: Apr. 22, 2025

(51) Int. Cl. B60R 7/04; A62B 3/00

(52) U.S. Cl. CPC B60R 7/043; A62B 3/005

(57) ABSTRACT

A multi-function car seat gap filler, no longer an ordinary gap filler, but utilizes the gap, which is the closest position to the driver or passenger, to provide the emergency items in case of emergency, no need to move any distance, in the shortest possible time, these emergency items are stored at elastic cuboid block, and can be pulled out immediately by the driver or passenger using a guiding strip.

### CROSS-REFERENCES

This application is based upon and claims the benefit of priority from US Utility patent application No.: 19/074,316 and US design patent application No.: 29/992,467

### BACKGROUND OF THE INVENTION

The present invention relates to the technical field of a car seat gap filler, and more specifically relates to a multi-function car seat gap filler.

The multi-function car seat gap filler not only prevents items from falling into the gap between the car seat and the console, but also has more functions, to store emergency items, like mini window breaker, mini fire extinguisher and so on.

A prior art, most of these car seat gap fillers have only single function, to prevent items from falling into the gap between car seat and center console, but this invention, as a multi-function car seat gap filler, utilizing the gap, which is the closest position to the driver or passenger, is a unique design related to providing the most critical survival equipment in case of emergency within a shortest time.

Therefore, such multi-function car seat gap fillers are very necessary.

### SUMMARY OF THE INVENTION

A multi-function car seat gap filler comprises an elastic cuboid block, an emergency item fixing device, emergency items, guiding strips, a pair of seat belt socket holder;

The elastic cuboid block has elasticity, can be inserted into the gap between the car seat and the center console through its deformation characteristics;

The emergency items fixing device is located at the positions of the elastic cuboid block, comprising the top surface, the front end, the back end, the bottom end and the side wall of elastic cuboid block, the method of emergency items fixing to the elastic cuboid block comprises adhesion, suspension, hook, Velcro strap, magnetic attraction, inlay, built-in the elastic cuboid block, and an empty storage spaces attached to the elastic cuboid block, etc.

The storage space is the space to store the emergency items;

The empty storage space attached to the elastic cuboid block is under the elastic cuboid block, and has two openings at the both ends;

The inlay, built-in storage space of the elastic cuboid block is in anywhere of the elastic cuboid block, with openings;

The empty storage space under the elastic cuboid block can be a complete space or divided into multiple spaces;

Under the condition of using Velcro, zipper or relative materials of storage space, the storage spaces can be closed, opened, space size can be expanded or reduced;

The emergency items are the most needed tools or items in emergency situations, comprise mini window breakers, mini fire extinguisher, mini First Aids Kit, etc.;

The guiding strip is a type of traction strip that directly or indirectly connecting emergency item(s), after extending above the elastic cuboid block, it is easy for being held and pulled by the driver or passenger in case of emergency;

The inlay, built-in storage space of elastic cuboid block, using Velcro, zipper, etc. to seal the openings.

The end of guiding strip is fixed to the surface of the elastic cuboid block, normally two guiding strips are needed, one guiding strip is extended from the front end of a cuboid block, another guiding strip is extended from the rear end of the cuboid block;

The surfaces of the guiding strips are printed with bright color warning words, so that driver or passenger can notice it while fastening seat belts;

Both guiding strips can be pulled by hand in emergency situations, without moving a distance, in the shortest possible time, to flip the elastic cuboid block 180 degrees and instantly bring the emergency items to the driver and passenger;

The car seat belt socket holder is on one side of the elastic cuboid block, has elasticity, and when the elastic cuboid block is flipped 180 degrees, the car seat belt socket holder’s resistance does not affect the flipping of the elastic cuboid block

### BRIEF DESCRIPTION OF DRAWINGS

FIG. 1 is the structure schematic diagram of the three dimensional of a preferred embodiment of the present invention.

FIG. 2 is the storage space divided into two parts schematic diagram of the three dimensional of a preferred embodiment of the present invention;

FIG. 3 is the state schematic diagram of the three dimensional of a preferred embodiment of the present invention when one guiding strip is opened;

FIG. 4 is the state schematic diagram of the three dimensional of a preferred embodiment of the present invention when another guiding strip is opened;

FIG. 5 is the details of the guiding strip and warning words.

### DETAILED DESCRIPTION OF THE INVENTION

In order to further explain the technical solutions of the present invention, the present invention will be explained in detail by the specific embodiments.

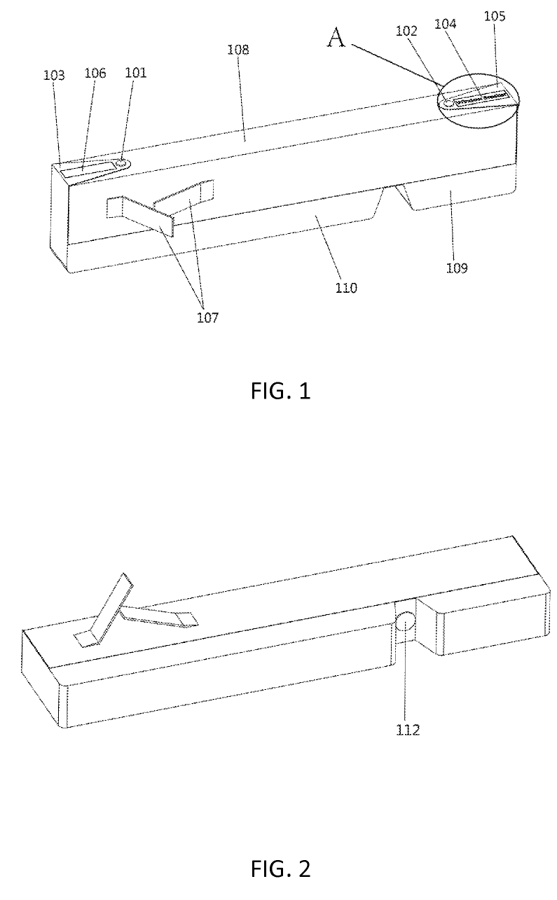

Referring to FIG. 1, the elastic cuboid block 108 comprises snap fastener 101, snap fastener 102, guiding strip 103, guiding strip 105, printed color warning words 104, pending printing area 106, car seat belt socket holder 107;

Referring to FIG. 1, storage space109, storage space110 are is located below the elastic cuboid block 108;

Referring to FIG. 2, snap fastener 112 divides the long, empty storage place into two parts;

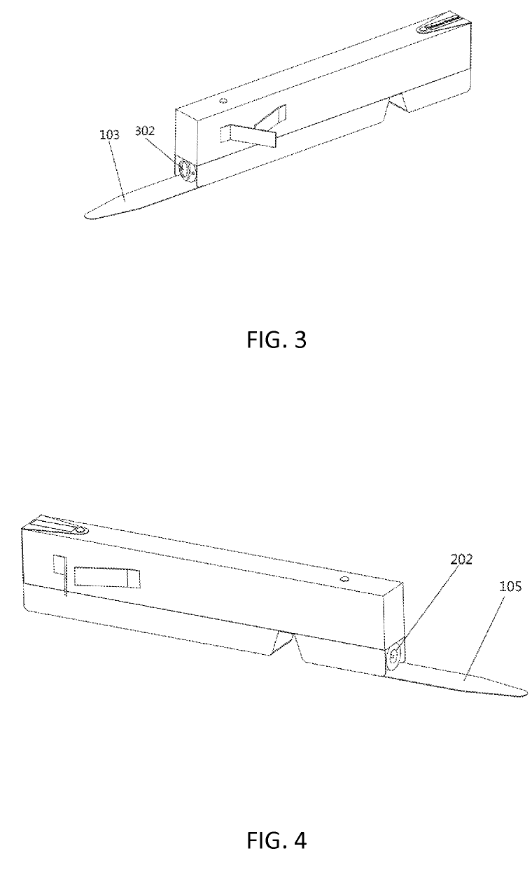

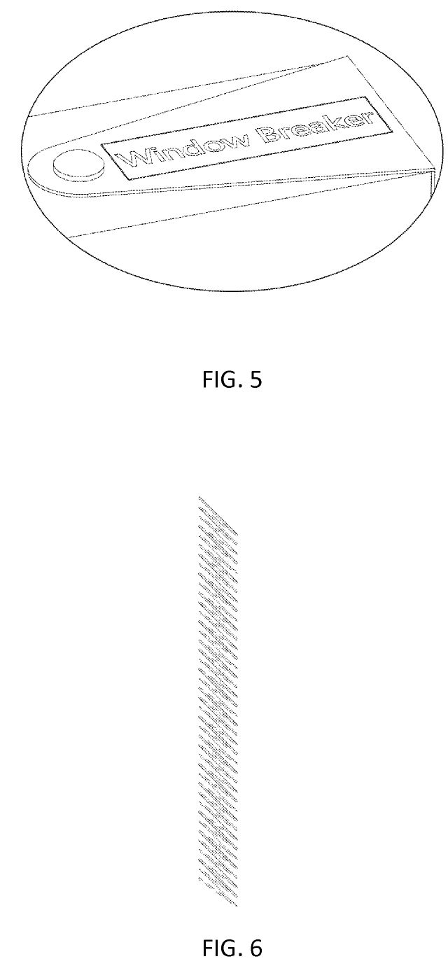

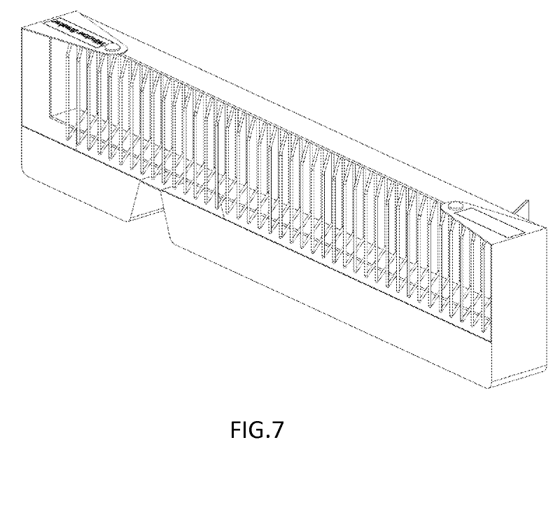

Referring to FIG. 3, the guiding strip103 is opened, mini fire extinguisher 302 is placed in the storage space 110;

Referring to FIG. 4, the guiding strip105 is opened, mini window breaker 302 is placed in the storage space 109;

Referring to FIGS. 1 and 4, A area shows the details of snap fastener 102, printed color warning words 104, guiding strip 105.

The present disclosure is not limited to the above embodiment and may be changed as appropriate without departing from the scope. For example, use different fixing methods to fix emergency items in other places; pop up emergency items through other means, etc., is also considered same design;

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

### DESCRIPTION OF EMBODIMENT

FIG. 1 depicts the emergency item fixing device is realized by storage place under the elastic cuboid block 108, the warning words 104 printed on the surface of the guiding strip 105 is window breaker;

FIG. 2 depicts the storage place is divided into two parts, 109, 110;

FIG. 2 depicts the emergency item is mini fire extinguisher 302 and is stored into the empty storage place 110, this state shows that the guiding strip 103 is open;

FIG. 4 depicts the emergency item is mini window breaker 202 and is stored into the empty storage place 109, this state shows that the guiding strip 105 is open;

when the guiding strip 105 is pulled by the driver or passenger, snap fastener102 will be separated, the mini window breaker 202 will be pulled up.

What is claimed is:

1. A multi-function car seat gap filler comprises
An elastic cuboid block;
An emergency item fixing device;
Emergency items;
Guiding strips;
A pair of seat belt socket holder.

2. The multi-function car seat gap filler of claim 1, wherein the elastic cuboid block has elasticity, can be inserted into the gap between the car seat and the center console through its deformation characteristics.

3. The multi-function car seat gap filler of claim 1, wherein the emergency items fixing device is located at the positions of the elastic cuboid block, comprising the top surface,the front end, the back end, the bottom end and the side wall of elastic cuboid block, the method of emergency items fixing to the elastic cuboid block comprises adhesion,suspension, hook, Velcro strap, magnetic attraction, inlay, built-in the elastic cuboid block, and an empty storage spaces attached to the elastic cuboid block, etc.

4. The multi-function car seat gap filler of claim 3, wherein the empty storage space attached to the elastic cuboid block is under the elastic cuboid block, and has two openings at both ends, the storage space is the space to store the emergency items.

5. The multi-function car seat gap filler of claim 3, wherein the inlay, built-in storage space of the elastic cuboid block is in anywhere of the elastic cuboid block, with openings.

6. The multi-function car seat gap filler of claim 3, wherein The empty storage space under the elastic cuboid block can be a complete space or divided into multiple spaces.

7. The multi-function car seat gap filler of claim 3, wherein under the condition of using Velcro, zipper or relative materials of storage space, the storage spaces can be closed,opened, space size can be expanded or reduced.

8. The multi-function car seat gap filler of claim 1, wherein the emergency items are the most needed tools or items in emergency situations, comprise mini window breaker,mini fire extinguisher, mini set of First Aids Kit, etc.

9. The multi-function car seat gap filler of claim 1, wherein a guiding strip is a type of traction strip that directly or indirectly connecting emergency item(s), after extending above the elastic cuboid block, it is easy for being held and pulled by the driver or passenger in case of emergency.

10. The multi-function car seat gap filler of claim 5, wherein the inlay, built-in storage space of elastic cuboid block, using Velcro, zipper, etc. to seal the openings.

11. The multi-function car seat gap filler of claim 1, wherein the surfaces of the guiding strips are printed with bright color warning words, so that driver or passenger can notice it while fastening seat belts.

12. The multi-function car seat gap filler of claim 8, wherein both guiding strips can be pulled by hand in emergency situations, without moving a distance, within the shortest possible time, to flip the elastic cuboid block 180 degrees and instantly bring the emergency item(s) to the driver or passenger.

13. The multi-function car seat gap filler of claim 1, wherein the car seat belt socket holder is on one side of the elastic cuboid block, has elasticity, and when the elastic cuboid block is flipped 180 degrees, the car seat belt socket holder's resistance does not affect the flipping of the elastic cuboid block;

14. The multi-function car seat gap filler of claim 2, wherein the elastic cuboid block comprises leather casing, and built in sponge;

15. The multi-function car seat gap filler of claim 2, wherein the elastic cuboid block comprises leather casing, and compressible and deformable spring, the spring material comprises steel, high performance plastics.
